(19) United States
(12) Patent Application Publication
(10) Pub. No.: US 2019/0062608 A1
(43) Pub. Date: Feb. 28, 2019

(54) ACRYLIC BLOCK COPOLYMER-BASED ASSEMBLY LAYER FOR FLEXIBLE DISPLAYS

(71) Applicant: 3M INNOVATIVE PROPERTIES COMPANY, St. Paul, MN (US)

(72) Inventors: Marie Aloshyna ep Lesuffleur, Painted Post, NY (US); Albert I. Everaerts, Tucson, AZ (US); Belma Erdogan-Haug, Woodbury, MN (US)

(21) Appl. No.: 15/574,218

(22) PCT Filed: Jun. 1, 2016
(86) PCT No.: PCT/US2016/035193

§ 371 Date: Nov. 15, 2017

Related U.S. Application Data
(60) Provisional application No. 62/170,514, filed on Jun. 3, 2015.

(51) Int. Cl. C09J 153/00; C09J 7/10; B32B 7/06; B32B 7/12; B32B 27/08; B32B 27/18; B32B 27/22; B32B 27/30; B32B 37/10; B32B 37/06

(52) U.S. Cl. CPC C09J 153/00; B32B 2457/206; B32B 7/06; B32B 7/12; B32B 27/08; B32B 27/18; B32B 27/22; B32B 27/308; B32B 37/10; B32B 37/06; C09J 2433/00; C09J 2453/00; C09J 2203/318; C09J 2205/114; B32B 2270/00; B32B 2307/412; B32B 2307/542; B32B 2307/546; B32B 2307/548; B32B 2307/748; B32B 2457/20; C09J 7/10

(57) ABSTRACT

The present invention is an assembly layer for a flexible device. The assembly layer is derived from precursors including an acrylic block copolymer including (a) at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block, and (b) at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10° C., and wherein the acrylic block copolymer comprises about 50 to about 95 weight percent B block. Within a temperature range of between about −30° C. to about 90° C., the assembly layer has a shear storage modulus at a frequency of 1 rad/sec that does not exceed about 2 MPa, a shear creep compliance (J) of at least about 6×10^{-6 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.}

### FIELD OF THE INVENTION

The present invention is related generally to the field of flexible assembly layers. In particular, the present invention is related to an acrylic block copolymer-based flexible assembly layer.

### BACKGROUND

A common application of pressure-sensitive adhesives in the industry today is in the manufacturing of various displays, such as computer monitors, TVs, cell phones and small displays (in cars, appliances, wearables, electronic equipment, etc.). Flexible electronic displays, where the display can be bent freely without cracking or breaking, is a rapidly emerging technology area for making electronic devices using, for example, flexible plastic substrates. This technology allows integration of electronic functionality into non-planar objects, conformity to desired design, and flexibility during use that can give rise to a multitude of new applications.

With the emergence of flexible electronic displays, there is an increasing demand for adhesives, and particularly for optically clear adhesives (OCA), to serve as an assembly layer or gap filling layer between an outer cover lens or sheet (based on glass, PET, PC, PMMA, polyimide, PEN, cyclic olefin copolymer, etc.) and an underlying display module of electronic display assemblies. The presence of the OCA improves the performance of the display by increasing brightness and contrast, while also providing structural support to the assembly. In a flexible assembly, the OCA will also serve at the assembly layer, which in addition to the typical OCA functions, may also absorb most of the folding induced stress to prevent damage to the fragile components of the display panel and protect the electronic components from breaking under the stress of folding. The OCA layer may also be used to position and retain the neutral bending axis at or at least near the fragile components of the display, such as for example the barrier layers, the driving electrodes, or the thin film transistors of an organic light emitting display (OLED).

If used outside of the viewing area of a display or photo-active area of a photovoltaic assembly, it is not necessary that the flexible assembly layer is optically clear. Indeed, such material may still be useful for example as a sealant at the periphery of the assembly to allow movement of the substrates while maintaining sufficient adhesion to seal the device.

Typical OCAs are visco-elastic in nature and are meant to provide durability under a range of environmental exposure conditions and high frequency loading. In such cases, a high level of adhesion and some balance of visco-elastic property is maintained to achieve good pressure-sensitive behavior and incorporate damping properties in the OCA. However, these properties are not fully sufficient to enable foldable or durable displays.

Due to the significantly different mechanical requirements for flexible display assemblies, there is a need to develop novel adhesives for application in this new technology area. Along with conventional performance attributes, such as optical clarity, adhesion, and durability, these OCAs need to meet a new challenging set of requirements such as bendability and recoverability without defects and delamination

### SUMMARY

In one embodiment, the present invention is an assembly layer for a flexible device. The assembly layer is derived from precursors including an acrylic block copolymer including (a) at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block, and (b) at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10° C., and wherein the acrylic block copolymer comprises about 50 to about 95 weight percent B block. Within a temperature range of between about −30° C. to about 90 ° C., the assembly layer has a shear storage modulus at a frequency of 1 rad/sec that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

In another embodiment, the present invention is a laminate including a first substrate, a second substrate, and an assembly layer positioned between and in contact with the first substrate and the second substrate. The assembly layer is derived from precursors including an acrylic block copolymer including (a) at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block, and (b) at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10° C., and wherein the acrylic block copolymer comprises about 50 to about 95 weight percent B block. Within a temperature range of between about −30° C. to about 90° C., the assembly layer has a shear storage modulus at a frequency of 1 rad/sec that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

In yet another embodiment, the present invention is a method of adhering a first substrate and a second substrate, wherein both of the first and the second substrates are flexible. The method includes positioning an assembly layer between the first substrate and the second substrate and applying pressure and/or heat to form a laminate. The assembly layer is derived from precursors including an acrylic block copolymer including (a) at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block, and (b) at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10° C., and wherein the acrylic block copolymer comprises about 50 to about 95 weight percent B block. Within a temperature range of between about −30° C. to about 90° C., the assembly layer has a shear storage modulus at a frequency of 1 rad/sec that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

### BRIEF DESCRIPTION OF THE DRAWINGS

FIG. 1A is a photograph of a recovery angle test configuration used to test performance of a flexible display device including an assembly layer of the present invention with the test specimen on a mandrel before release.

FIG. 1B is a photograph of the recovery angle test configuration of FIG. 1A with a test specimen that has been unfastened and allowed to recover for 90 seconds.

### DETAILED DESCRIPTION

The present invention is an acrylic block copolymer-based assembly layer usable, for example, in a flexible devices, such as electronic displays, flexible photovoltaic cells or solar panels, and wearable electronics. As used herein, the term “assembly layer” refers to a layer that possesses the following properties: (1) adherence to at least two flexible substrates and (2) sufficient ability to hold onto the adherends during repeated flexing to pass the durability testing. As used herein, a “flexible device” is defined as a device that can undergo repeated flexing or roll up action with a bend radius as low as 200 mm, 100 mm, 50 mm, 20 mm, 10 mm, 5 mm, or even less than 2 mm. The acrylic block copolymer-based assembly layer is soft, is predominantly elastic with good adhesion to plastic films or other flexible substrates like glass, and has high tolerance for shear loading. In addition, the acrylic block copolymer-based assembly layer has relatively low modulus, high percent compliance at moderate stress, a low glass transition temperature, generation of minimal peak stress during folding, and good strain recovery after applying and removing stress, making it suitable for use in a flexible assembly because of its ability to withstand repeated folding and unfolding. Under repeated flexing or rolling of a multi-layered construction, the shear loading on the adhesive layers becomes very significant and any form of stress can cause not only mechanical defects (delamination, buckling of one or more layers, cavitation bubbles in the adhesive, etc.) but also optical defects or Mura. Unlike traditional adhesives that are mainly visco-elastic in character, the acrylic block copolymer-based assembly layer of the present invention is predominantly elastic at use conditions, yet maintains sufficient adhesion to pass a range of durability requirements. In one embodiment, the acrylic block copolymer-based assembly layer is optically clear and exhibits low haze, high visible light transparency, anti-whitening behavior, and environmental durability.

The acrylic block copolymer-based assembly layer of the present invention is prepared from select acrylic block copolymer compositions cross-linked at different levels to offer a range of elastic properties, while still generally meeting all optically clear requirements. For example, an acrylic block copolymer-based assembly layer used within a laminate with a folding radius as low as 5 mm or less can be obtained without causing delamination or buckling of a laminate or bubbling of the adhesive.

As used herein, the term “acrylic” is synonymous with “(meth)acrylate” and refers to polymeric material that is prepared from acrylates, methacrylates, or derivatives thereof.

As used herein, the term “polymer” refers to a polymeric material that is a homopolymer or a copolymer. As used herein, the term “homopolymer” refers to a polymeric material that is the reaction product of one monomer. As used herein, the term “copolymer” refers to a polymeric material that is the reaction product of at least two different monomers. As used herein, the term “block copolymer” refers to a copolymer formed by covalently bonding at least two different polymeric blocks to each other, but that does not have a comb-like structure. The two different polymeric blocks are referred to as the A block and the B block.

In one embodiment, the assembly layer of the present invention includes at least one multi-block copolymer (for example, ABA or star block (AB)n where n represents the number of arms in the star block) and an optional diblock (AB) copolymer. Such block copolymers are physically cross-linked due to the phase separation of a hard A block and a soft B block. Additional cross-linking may be introduced by a covalent crosslinking mechanism (i.e. thermally induced or using UV irradiation, high energy irradiation such as e-beam, or ionic crosslinking). This additional cross-linking can be done in the hard block A, the soft block B, or both. In another embodiment, the acrylic block copolymer assembly layer is based on at least one multi-block copolymer, having, for example, poly methyl methacrylate (PMMA) hard A blocks and one or more poly-n-butyl acrylate (PnBA) soft B blocks. In yet another embodiment, the acrylic block copolymer-based assembly layer is based on at least one multi-block copolymer, having, for example, polymethyl methacrylate (PMMA) hard A blocks and one or more poly-n-butyl acrylate (PnBA) soft B blocks, combined with at least one AB diblock copolymer, having, for example, a poly methyl methacrylate (PMMA) hard A block and a poly-n-butyl acrylate (PnBA) soft B block.

The assembly layer contains a block copolymer that includes the reaction product of at least two A block polymeric units and at least one B block polymeric unit (i.e., at least two A block polymeric units are covalently bonded to at least one B block polymeric unit). Each A block, which has a Tg of at least 50° C., is the reaction product of a first monomer composition that contains an alkyl methacrylate, an aralkyl methacrylate, an aryl methacrylate, or a combination thereof. The A block may also be made from styrenic monomers, such as styrene. The B block, which has a Tg no greater than about 10° C., particularly no greater than about 0° C., and more particularly no greater than about −10° C., is the reaction product of a second monomer composition that contains an alkyl (meth)acrylate, a heteroalkyl (meth)acrylate, a vinyl ester, or a combination thereof. The block copolymer contains between about 5 and about 50 weight percent A block and between about 50 to about 95 weight percent B block based on the weight of the block copolymer.

The block copolymer in the assembly layer can be a triblock copolymer (i.e., (A-B-A) structure) or a star block copolymer (i.e., (A-B)ₙ-structure where n is an integer of at least 3). Star-block copolymers, which have a central point from which various branches extend, are also referred to as radial copolymers.

Each A block polymeric unit as well as each B block polymeric unit can be a homopolymer or copolymer. The A block is usually an end block (i.e., the A block forms the ends of the copolymeric material), and the B block is usually a midblock (i.e., the B block forms a middle portion of the copolymeric material). The A block is typically a hard block that is a thermoplastic material, and the B block is typically a soft block that is an elastomeric material.

The A block tends to be more rigid than the B block (i.e., the A block has a higher glass transition temperature than the B block). The A block has a Tg of at least about 50° C. whereas the B block has a Tg no greater than about 10° C. The A block tends to provide the structural and cohesive strength for the acrylic block copolymer.

The coated block copolymer usually has an ordered multiphase morphology, at least at temperatures of up to about 100° C. Because the A block has a solubility parameter sufficiently different than the B block, the A block phase and the B block phase are usually separated. The block copolymer can have distinct regions of reinforcing A block domain (e.g., nanodomains) in a matrix of the softer, elastomeric B blocks. That is, the block copolymer often has a discrete, discontinuous A block phase in a substantially continuous B block phase.

Each A block is the reaction product of a first monomer mixture containing at least one methacrylate monomer of Formula I

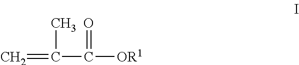

where R¹ is an alkyl (i.e., the monomer according to Formula I can be an alkyl methacrylate), an aralkyl (i.e., the monomer according to Formula I can be an aralkyl methacrylate), or an aryl group (i.e., the monomer according to Formula I can be an aryl methacrylate). Suitable alkyl groups often have 1 to 6 carbon atoms. When the alkyl group has more than 2 carbon atoms, the alkyl group can be branched or cyclic. Suitable aralkyl groups (i.e., an aralkyl is an alkyl group substituted with an aryl group) often have 7 to 12 carbon atoms while suitable aryl groups often have 6 to 12 carbon atoms.

Exemplary monomers according to Formula I include methyl methacrylate, ethyl methacrylate, isopropyl methacrylate, isobutyl methacrylate, tert-butyl methacrylate, cyclohexyl methacrylate, phenyl methacrylate, and benzyl methacrylate.

In addition to the monomers of Formula I, the A block can contain up to about 10 parts of a polar monomer such as (meth)acrylic acid, a (meth)acrylamide, or a hydroxyalkyl (meth)acrylate. These polar monomers can be used, for example, to adjust the Tg (i.e., the Tg of the A block remains at least 50° C., however) and the cohesive strength of the A block. Additionally, these polar monomers can function as reactive sites for chemical or ionic crosslinking, if desired.

As used herein, the term “(meth)acrylic acid” refers to both acrylic acid and methacrylic acid. As used herein, the term “(meth)acrylamide” refers to both an acrylamide and a methacrylamide. The (meth)acrylamide can be a N-alkyl (meth)acrylamide or a N,N-dialkyl (meth)acrylamide where the alkyl substituent has 1 to 10, 1 to 6, or 1 to 4 carbon atoms. Exemplary (meth)acrylamides include acrylamide, methacrylamide, N-methyl acrylamide, N-methyl methacrylamide, N,N-dimethyl acrylamide, N,N-dimethyl methacrylamide, and N-octyl acrylamide.

As used herein, the term “hydroxyalkyl (meth)acrylate” refers to a hydroxyalkyl acrylate or a hydroxyalkyl methacrylate where the hydroxy substituted alkyl group has 1 to 10, 1 to 6, or 1 to 4 carbon atoms. Exemplary hydroxyalkyl (meth)acrylates include 2-hydroxyethyl acrylate, 2-hydroxyethyl methacrylate, 3-hydroxypropyl acrylate, 3-hydroxypropyl methacrylate, and 4-hydroxybutyl acrylate. Hydroxyalkyl (meth)acrylamides may also be used.

The A blocks in the block copolymer can be the same or different. They may be slightly different in composition, different in molecular weight, or both, as long as they meet the general criteria of a hard A block (for example, their Tg is at least about 50° C.). In some block copolymers, each A block is a poly(methyl methacrylate). In more specific examples, the block copolymer can be a triblock or a starblock copolymer where each endblock is a poly(methyl methacrylate).

The weight average molecular weight (Mw) of each A block is usually at least about 5,000 g/mole. In some block copolymers, the A block has a weight average molecular weight of at least about 8,000 g/mole or at least about 10,000 g/mole. The weight average molecular weight of the A block is usually less than about 30,000 g/mole or less than about 20,000 g/mole. The weight average molecular weight of the A block can be, for example, about 5,000 to about 30,000 g/mole, about 10,000 to about 30,000 g/mole, about 5,000 to about 20,000 g/mole, or about 10,000 to about 20,000 g/mole.

Each A block has a Tg of at least about 50° C. In some embodiments, the A block has a Tg of at least about 60° C., at least about 80° C., at least about 100° C., or at least about 120° C. The Tg is often no greater than about 200° C., no greater than about 190° C., or no greater than about 180° C. For example, the Tg of the A block can be about 50° C. to about 200° C., about 60° C. to about 200° C., about 80° C. to about 200° C., about 100° C. to about 200° C., about 80° C. to about 180° C., or about 100° C. to about 180° C.

The A blocks can be thermoplastic. As used herein, the term “thermoplastic” refers to polymeric material that flows when heated and then returns to its original state when cooled to room temperature. However, under some conditions (e.g., applications where solvent resistance or higher temperature performance is desired), the thermoplastic block copolymers can be covalently cross-linked. Upon cross-linking, the materials lose their thermoplastic characteristics and become thermoset materials. As used herein, the term “thermoset” refers to polymeric materials that become infusible and insoluble upon heating and that do not return to their original chemical state upon cooling. Thermoset materials tend to be insoluble and resistant to flow. In some applications, the acrylic block copolymer is a thermoplastic material that is transformed to a thermoset material during or after formation of a coating that contains a block copolymer capable of being covalently crosslinked.

The B block is the reaction product of a second monomer composition that contains an alkyl (meth)acrylate, a heteroalkyl (meth)acrylate, a vinyl ester, or a combination thereof. As used herein, the term “alkyl (meth)acrylate” refers to an alkyl acrylate or an alkyl methacrylate. As used herein, the term “heteroalkyl (meth)acrylate” refers to a heteroalkyl acrylate or heteroalkyl methacrylate with the heteroalkyl having at least two carbon atoms and at least one catenary heteroatom (e.g., sulfur or oxygen).

Exemplary vinyl esters include, but are not limited to, vinyl acetate, vinyl 2-ethyl-hexanoate, and vinyl neodecanoate.

Exemplary alkyl (meth)acrylates and heteroalkyl (meth)acrylates are often of Formula II:

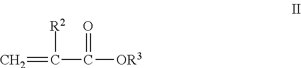

where R² is hydrogen or methyl; and R³ is a C₁₋₂₄ alkyl or a C₂₋₂₄ heteroalkyl. When R² is hydrogen (i.e., the monomer according to Formula II is an acrylate), the R³ group can be linear, branched, cyclic, or a combination thereof. When R² is methyl (i.e., the monomer according to Formula II is a methacrylate) and R³ has 1 or 2 carbon atoms, the R³ group is linear. When R² is methyl and R³ has at least 3 carbon atoms, the R³ group can be linear, branched, cyclic, or a combination thereof. In order to lower the modulus of the acrylic block copolymer and enhance its elongation it may be beneficial to decrease the entanglement of the polymer midblock. For example, if the B block is a homopolymer it may be desirable to use at least predominantly C₄₋₂₄ alkyl acrylate instead of those having less than 4 carbons in the alkyl group.

Suitable monomers according to Formula II include, but are not limited to, n-butyl acrylate, decyl acrylate, 2-ethoxy ethyl acrylate, 2-ethoxy ethyl methacrylate, isoamyl acrylate, n-hexyl acrylate, n-hexyl methacrylate, isobutyl acrylate, isodecyl acrylate, isodecyl methacrylate, isononyl acrylate, 2-ethylhexyl acrylate, 2-ethylhexyl methacrylate, isooctyl acrylate, isostearyl acrylate, isooctyl methacrylate, isotridecyl acrylate, lauryl acrylate, lauryl methacrylate, isomyristyl acrylate, 2-methoxy ethyl acrylate, 2-methylbutyl acrylate, 4-methyl-2-pentyl acrylate, n-octyl acrylate, n-propyl acrylate, and n-octyl methacrylate.

Acrylic blocks prepared from monomers according to Formula II that are commercially unavailable or that cannot be polymerized directly can be provided through an esterification or trans-esterification reaction. For example, a (meth)acrylate that is commercially available can be hydrolyzed and then esterified with an alcohol to provide the (meth)acrylate of interest. This process may leave some residual acid in the B block. Alternatively, a higher alkyl (meth)acrylate ester can be derived from a lower alkyl (meth)acrylate ester by direct transesterification of the lower alkyl (meth)acrylate with a higher alkyl alcohol.

The B block can include up to about 30 parts polar monomers as long as the Tg of the B block is no greater than about 10° C. Polar monomers include, but are not limited to, (meth)acrylic acid; (meth)acrylamides such as N-alkyl (meth)acrylamides and N,N-dialkyl (meth)acrylamides; hydroxy alkyl (meth)acrylates; hydroxy alkyl (meth) acrylamides, and N-vinyl lactams such as N-vinyl pyrrolidone and N-vinyl caprolactam. The polar monomers can be included in the B block to adjust the Tg or the cohesive strength of the B block. Additionally, the polar monomers can function as reactive sites for chemical or ionic crosslinking, if desired.

The B block typically has a Tg that is no greater than about 20° C. In some embodiments, the B block has a Tg that is no greater than about 10° C., no greater than about 0° C., no greater than about −5° C., or no greater than about −10° C. The Tg often is no less than about −80° C., no less than about −70° C., or no less than about −50° C. For example, the Tg of the B block can be about −70° C. to about 20° C., about −60° C. to about 20° C., about −70° C. to about 10° C., about −60° C. to about 10° C., about −70° C. to about 0° C., about −60° C. to about 0° C., about −70° C. to about −10° C., or about −60° C. to about −10° C.

The B block tends to be elastomeric. As used herein, the term “elastomeric” refers to a polymeric material that can be stretched to at least twice its original length and then retracted to approximately its original length upon release. In some assembly layer compositions, additional elastomeric material is added. This added elastomeric material should not adversely affect the optical clarity or the adhesive properties (e.g., the storage modulus) of the assembly layer. An example of such elastomeric material is an acrylate copolymer that is miscible with the B block of the block copolymer. The modulus of the B block can affect the tackiness of the block copolymer (e.g., block copolymers with a lower rubbery plateau storage modulus, as determined using Dynamic Mechanical Analysis, tend to be tackier).

In some embodiments, the monomer according to Formula II is an alkyl (meth)acrylate with the alkyl group having 1 to 24, particularly 4 to 24, or more particularly 4 carbon atoms. High alkyl (meth)acrylates (alkyl group having at least 12 carbons) tend to yield materials with lower dielectric constant and low water uptake, which can be beneficial in assemblies sensitive to electronic noise, corrosion, or electrolytic migration. Low alkyl(meth)acrylates, such as those having 1 or 2 carbons may yield too high a Tg and they are typically copolymerized with other alkylacrylates to reduce the Tg of the polymer. In some examples, the monomer is an acrylate. Acrylate monomers tend to be less rigid than their methacrylate counterparts. For example, the B block can be a poly(n-butyl acrylate).

The weight average molecular weight of the B block is usually at least about 30,000 g/mole. In some block copolymers, the B block has a weight average molecular weight of at least about 40,000 g/mole or at least about 50,000 g/mole. The weight average molecular weight is generally no greater than about 200,000 g/mole. The B block usually has a weight average molecular weight no greater than 150,000 g/mole, no greater than about 100,000 g/mole, or no greater than about 80,000 g/mole. In some block copolymers, the B block has a weight average molecular weight of about 30,000 g/mole to about 200,000 g/mole, about 30,000 g/mole to about 100,000 g/mole, about 30,000 g/mole to about 80,000 g/mole, about 40,000 g/mole to about 200,000 g/mole, about 40,000 g/mole to about 100,000 g/mole, or about 40,000 g/mole to about 80,000 g/mole.

To reduce the physical crosslink density of the multi-block copolymer, one may add some diblock copolymer. In order to be miscible, the diblock copolymer hard block segment A and soft block segment B are typically similar in composition as the A and B block in the multi-block copolymer. However, some differences are possible as long as the respective A blocks remain miscible and the B blocks retain at least some level of miscibility, especially in the case where optical clarity is needed. The ratio of the multi-block copolymer to diblock copolymer blend is typically in the range of between about 100/0 and about 20/80 by weight, particularly between about 100/0 and about 25/75, and even more particularly between about 100/0 and 30/70.

The block copolymers usually contain about 5 to about 50 parts A block and about 50 to about 95 parts B block based on the weight of the block copolymer. For example, the copolymer can contain about 5 to about 40 parts A block and about 60 to about 95 parts B block, about 10 to about 40 parts A block and about 60 to about 90 parts B block, about 30 to about 40 parts A block and about 60 to about 70 parts B block, about 20 to about 35 parts A block and about 65 to about 80 parts B block, about 25 to about 35 parts A block and about 65 to about 75 parts B block, or about 30 to about 35 parts A block and about 65 to about 70 parts B block. Higher amounts of the A block tend to increase the cohesive strength of the copolymer. If the amount of the A block is too high, the tackiness of the block copolymer may be unacceptably low. Further, if the amount of the A block is too high (for example more than 50 parts based on weight of the block copolymer), the morphology of the block copolymer may be inverted from the desirable arrangement where the B block forms the continuous phase to where the A block forms the continuous phase and the block copolymer has characteristics of a thermoplastic material rather than of a predominantly elastic assembly layer material.

The acrylic block copolymer-based assembly layer can be inherently tacky. For example only one multi-block copolymer may be used, or a mixture of block copolymers (more than one multi-block, multi-block with diblock, etc.) may be used, yielding a tacky assembly layer. If desired, tackifiers can be added to the block copolymer composition before formation of the acrylic block copolymer-based assembly layer. Useful tackifiers include, for example: rosin ester resins, aromatic hydrocarbon resins, aliphatic hydrocarbon resins, terpene, and terpene phenolic resins. In general, light-colored tackifiers selected from hydrogenated rosin esters, terpenes, or aromatic hydrocarbon resins are preferred. When included, the tackifier is added to the precursor mixture in an amount of between about 1 parts and about 70 parts by weight, particularly between about 5 and about 50 parts, more particularly between about 5 and about 40 parts and most particularly between 5 and 30 parts.

In one embodiment, the acrylic block copolymer-based assembly layer may be substantially free of acid to eliminate indium tin oxide (ITO) and metal trace corrosion that otherwise could damage touch sensors and their integrating circuits or connectors. “Substantially free” as used in this specification means less than about 2 parts by weight, particularly less than about 1 parts, and more particularly less than about 0.5 parts.

Other materials can be added to the precursor mixture for special purposes, including, for example: a plasticizer, a UV stabilizer, a UV absorber, nanoparticles, a cross-linker, a coupling agent, and other additives. Usually, the additives are selected to be compatible with the A or B block of the block copolymer or are dispersible in the composition. An additive is compatible in a phase (e.g., A block or B block) if it causes a shift in the glass transition temperature of that phase (assuming that the additive and the phase do not have the same Tg). Examples of these types of additives include plasticizers and tackifiers. In cases where the acrylic block copolymer-based assembly layer needs to be optically clear, other materials can be added to the precursor mixture, provided that they do not significantly reduce the optical clarity of the assembly layer. As used herein, the term “optically clear” refers to a material that has a luminous transmission of greater than about 90 percent, a haze of less than about 2 percent, and opacity of less than about 1 percent in the 400 to 700 nm wavelength range. Both the luminous transmission and the haze can be determined using, for example, ASTM-D 1003-92. Typically, the optically clear assembly layer is visually free of bubbles.

Fillers can also be added to the precursor mixture. Fillers typically do not change the Tg but can change the storage modulus. If optical clarity is desired, these fillers are often chosen to have a particle size that does not adversely affect the optical properties of the pressure sensitive adhesive composition. Examples of such filler include, but are not limited to, nanoparticles, such as silica, zirconia, titania, etc. These nanoparticles can be functionalized as known in the art, so they are more readily dispersed in the polymer matrix. Some of these particles can also be used to adjust the refractive index of the assembly layer.

The acrylic block copolymer-based assembly layer can be processed using, for example, solvent casting or hot melt processes.

In one process, the assembly layer components can be blended with a solvent to form a mixture. A solvent is selected that is a good solvent for both the A block and the B block of the block copolymer. Examples of suitable solvents include, but are not limited to, ethyl acetate, tetrahydrofuran, and methyl ethyl ketone. A coating is applied and then dried to remove the solvent. Once the solvent has been removed, the A block and the B block segments of the block copolymer tend to segregate to form an ordered, cohesively strong, multiphase morphology.

The disclosed compositions or precursors may be coated by any variety of coating techniques known to those of skill in the art, such as roll coating, spray coating, knife coating, die coating, and the like. Alternatively, the assembly layer composition may also be delivered as a hot melt. For example, the components of the assembly layer can be blended in an extruder and coated on a release liner or substrate.

The present invention also provides laminates including the acrylic block copolymer-based assembly layer. A laminate is defined as a multi-layer composite of at least one assembly layer sandwiched between two flexible substrate layers or multiples thereof. For example the composite can be a 3 layer composite of substrate/assembly layer/substrate; a 5-layer composite of substrate/assembly layer/substrate/assembly layer/substrate, and so on. The thickness, mechanical, electrical (such as dielectric constant), and optical properties of each of the flexible assembly layers in such multi-layer stack may be the same but they can also be different in order to better fit the design and performance characteristics of the final flexible device assembly. The laminates have at least one of the following properties: optical transmissivity over a useful lifetime of the article in which it is used, the ability to maintain a sufficient bond strength between layers of the article in which it is used, resistance or avoidance of delamination, and resistance to bubbling over a useful lifetime. The resistance to bubble formation and retention of optical transmissivity can be evaluated using accelerated aging tests. In an accelerated aging test, the acrylic block copolymer-based assembly layer is positioned between two substrates. The resulting laminate is then exposed to elevated temperatures often combined with elevated humidity for a period of time. Even after exposure to elevated temperature and humidity, the laminate, including the acrylic block copolymer-based assembly layer, will retain optical clarity. For example, the acrylic block copolymer-based assembly layer and laminate remain optically clear after aging at 70° C. and 90% relative humidity for approximately 72 hours and subsequently cooling to room temperature. After aging, the average transmission of the adhesive between 400 nanometers (nm) and 700 nm is greater than about 90% and the haze is less than about 5% and particularly less than about 2%.

In use, the acrylic block copolymer-based assembly layer will resist fatigue over thousands or more of folding cycles over a broad temperature range from well below freezing (i.e., −30 degrees C., −20 degrees C., or −10 degrees C.) to about 70, 85 or even 90° C. In addition, because the display incorporating the acrylic block copolymer-based assembly layer may be sitting static in the folded state for hours, the acrylic block copolymer-based assembly layer has minimal to no creep, preventing significant deformation of the display, deformation which may be only partially recoverable, if at all. This permanent deformation of the acrylic block copolymer-based assembly layer or the panel itself could lead to optical distortions or Mura, which is not acceptable in the display industry. Thus, the acrylic block copolymer-based assembly layer is able to withstand considerable flexural stress induced by folding a display device as well as tolerating high temperature, high humidity (HTHH) testing conditions. Most importantly, the acrylic block copolymer-based assembly layer has exceptionally low storage modulus and high elongation over a broad temperature range (including well below freezing; thus, low glass transition temperatures are preferred) and are cross-linked to produce an elastomer with little or no creep under static load.

During a folding or unfolding event, it is expected that the acrylic block copolymer-based assembly layer will undergo significant deformation and cause stresses. The forces resistant to these stresses will be in part determined by the modulus and thickness of the layers of the folding display, including the acrylic block copolymer-based assembly layer. To ensure a low resistance to folding as well as adequate performance, generation of minimal stress and good dissipation of the stresses involved in a bending event, the silicone-based assembly layer has a sufficiently low storage or elastic modulus, often characterized as shear storage modulus (G′). To further ensure that this behavior remains consistent over the expected use temperature range of such devices, there is minimal change in G′ over a broad and relevant temperature range. In one embodiment, the relevant temperature range is between about −30° C. to about 90° C. In one embodiment, the shear modulus is less than about 2 MPa, particularly less than about 1 MPa, more particularly less than about 0.5 MPa, and most particularly less than about 0.3 MPa over the entire relevant temperature range. Therefore, it is preferred to position the glass transition temperature (Tg), the temperature at which the material transitions to a glassy state, with a corresponding change in G′ to a value typically greater than about 10⁷ Pa, outside and below this relevant operating range. In one embodiment, the Tg of the acrylic block copolymer-based assembly layer in a flexible display is less than about 10° C., particularly less than about −10° C., and more particularly less than about −30° C. As used herein, the term “glass transition temperature” or “Tg”′ refers to the temperature at which a polymeric material transitions from a glassy state (e.g., brittleness, stiffness, and rigidity) to a rubbery state (e.g., flexible and elastomeric). The Tg can be determined, for example, using a technique such as Dynamic Mechanical Analysis (DMA). In one embodiment, the Tg of the acrylic block copolymer-based assembly layer in a flexible display is less than about 10° C., particularly less than about −10° C., and more particularly less than about −30° C.

The assembly layer is typically coated at a dry thickness of less than about 300 microns, particularly less than about 50 microns, particularly less than about 20 microns, more particularly less than about 10 microns, and most particularly less than about 5 microns. The thickness of the assembly layer may be optimized according to the position in the flexible display device. Reducing the thickness of the assembly layer may be preferred to decrease the overall thickness of the device as well as to minimize buckling, creep, or delamination failure of the composite structure.

The ability of the acrylic block copolymer-based assembly layer to absorb the flexural stress and comply with the radically changing geometry of a bend or fold can be characterized by the ability of such a material to undergo high amounts of strain or elongation under relevant applied stresses. This compliant behavior can be probed through a number of methods, including a conventional tensile elongation test as well as a shear creep test. In one embodiment, in a shear creep test, the acrylic block copolymer-based assembly layer exhibits a shear creep compliance (J) of at least about 6×10⁻⁶ 1/Pa, particularly at least about 20×10⁻⁶ 1/Pa, about 50×10⁻⁶ 1/Pa, and more particularly at least about 90×10⁻⁶ 1/Pa under an applied shear stress of between from about 5 kPa to about 500 kPa, particularly between about 20 kPa to about 300 kPa, and more particularly between about 50 kPa to about 200 kPa. The test is normally conducted at room temperature but could also be conducted at any temperature relevant to the use of the flexible device.

The acrylic block copolymer-based assembly layer also exhibits relatively low creep to avoid lasting deformations in the multilayer composite of a display following repeated folding or bending events. Material creep may be measured through a simple creep experiment in which a constant shear stress is applied to a material for a given amount of time. Once the stress is removed, the recovery of the induced strain is observed. In one embodiment, the shear strain recovery within 1 minute after removing the applied stress (at least one point of applied shear stress within the range of about 5 kPa to about 500 kPa) at room temperature is at least about 50%, particularly at least about 60%, about 70% and about 80%, and more particularly at least about 90% of the peak strain observed at the application of the shear stress. The test is normally conducted at room temperature but could also be conducted at any temperature relevant to the use of the flexible device.

Additionally, the ability of the acrylic block copolymer-based assembly layer to generate minimal stress and dissipate stress during a fold or bending event is critical to the ability of the acrylic block copolymer-based assembly layer to avoid interlayer failure as well as its ability to protect the more fragile components of the flexible display assembly. Stress generation and dissipation may be measured using a traditional stress relaxation test in which a material is forced to and then held at a relevant shear strain amount. The amount of shear stress is then observed over time as the material is held at this target strain. In one embodiment, following about 500% shear strain, particularly about 600%, about 700%, and about 800%, and more particularly about 900% strain, the amount of residual stress (measured shear stress divided by peak shear stress) observed after 5 minutes is less than about 50%, particularly less than about 40%, about 30%, and about 20%, and more particularly less than about 10% of the peak stress. The test is normally conducted at room temperature but could also be conducted at any temperature relevant to the use of the flexible device.

As an assembly layer, the acrylic block copolymer-based assembly layer must adhere sufficiently well to the adjacent layers within the display assembly to prevent delamination of the layers during the use of the device that includes repeated bending and folding actions. While the exact layers of the composite will be device specific, adhesion to a standard substrate such as PET may be used to gauge the general adhesive performance of the assembly layer in a traditional 180 degree peel test mode. The adhesive may also need sufficiently high cohesive strength, which can be measured, for example, as a laminate of the assembly layer material between two PET substrates in a traditional T-peel mode.

When the acrylic block copolymer-based assembly layer is placed between two substrates to form a laminate and the laminate is folded or bent and held at a relevant radius of curvature, the laminate does not buckle or delaminate between all use temperatures (−30° C. to 90° C.), an event that would represent a material failure in a flexible display device. In one embodiment, a multilayer laminate containing the acrylic block copolymer-based assembly layer does not exhibit failure when placed within a channel forcing a radius of curvature of less than about 200 mm, less than about 100 mm, less than about 50 mm, particularly less than about 20 mm, about 15 mm, about 10 mm, and about 5 mm, and more particularly less than about 2 mm over a period of about 24 hours. Furthermore, when removed from the channel and allowed to return from the bent orientation to its previously flat orientation, a laminate including the acrylic block copolymer-based assembly layer of the present invention does not exhibit lasting deformation and rather rapidly returns to a nearly flat orientation. In one embodiment, when held for 24 hours and then removed from the channel that holds the laminate with a radius of curvature of particularly less than about 50 mm, particularly less than about 20 mm, about 15 mm, about 10 mm, and about 5 mm, and more particularly less than about 3 mm, the composite returns to a nearly flat orientation where the final angle between the laminate, the laminate bend point and the return surface is less than about 50 degrees, more particularly less than about 40 degrees, about 30 degrees, and about 20 degrees, and more particularly less than about 10 degrees within 1 hour after the removal of the laminate from the channel. In other words, the included angle between the flat parts of the folded laminate goes from 0 degrees in the channel to an angle of at least about 130 degrees, particularly more than about 140 degrees, about 150 degrees, and about 160 degrees, and more particularly more than about 170 degrees within 1 hour after removal of the laminate from the channel. This return is preferably obtained under normal usage conditions, including after exposure to durability testing conditions.

In addition to the static fold testing behavior described above, the laminate including first and second substrates bonded with the acrylic block copolymer-based assembly layer does not exhibit failures such as buckling or delamination during dynamic folding simulation tests. In one embodiment, the laminate does not exhibit a failure event between all use temperatures (−30° C. to 90° C.) over a dynamic folding test in free bend mode (i.e. no mandrel used) of greater than about 10,000 cycles, particularly greater than about 20,000 cycles, about 40,000 cycles, about 60,000 cycles, and about 80,000 cycles, and more particularly greater than about 100,000 cycles of folding with a radius of curvature of less than about 50 mm, particularly less than about 20 mm, about 15 mm, about 10 mm, and about 5 mm, and more particularly less than about 3 mm.

To form a flexible laminate, a first substrate is adhered to a second substrate by positioning the assembly layer of the present invention between the first substrate and the second substrate. Additional layers may also be included to make a multi-layer stack. Pressure and/or heat is then applied to form the flexible laminate.

Advantages of the acrylic block copolymer-based assembly layers of the present invention include optical clarity with excellent weatherability, UV stability, low odor, solvent- or hot-melt processability, physical crosslinking (no additional chemical or radiation crosslinking step is necessary to obtain durable laminates), inherent tackiness even as pure elastomers, and a formulation space that delivers a broad range of rheological and adhesive properties for application in flexible electronics.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis. In these examples, RT refers to room temperature.

### Materials.

| | Abbreviation | |
|---|---|---|
| | or Trade | |
| Description | Designation | Source |
| Poly(methyl methacrylate) - poly(n- | Kurarity | Kuraray America |
| butyl acrylate) diblock copolymer | LA1114 | Inc., Houston, TX |
| Poly(methyl methacrylate) - poly(n- | Kurarity | Kuraray America |
| butyl acrylate) triblock copolymer | LA2330 | Inc., Houston, TX |
| Poly(methyl methacrylate) - poly(n- | Kurarity | Kuraray America |
| butyl acrylate) triblock copolymer | LA2140e | Inc., Houston, TX |
| Poly(methyl methacrylate) - poly(n- | Kurarity | Kuraray America |
| butyl acrylate) triblock copolymer | LA2250 | Inc., Houston, TX |
| Polyimide film | Kapton | DuPont USA, |
| | | Wilmington, DE |
| Polyethylene terephthalate (PET) film | Skyrol | SKC Films, |
| backing | SH81 | Covington, GA |
| Polyester silicone release liner | T10 release | Saint Gobain, |
| | liner | Valley Forge, PA, |

### Test Procedures

### Dynamic Mechanical Properties Test

To prepare samples for dynamic mechanical properties testing, three optically clear adhesive (OCA) layers of 13 mil thickness were laminated on top of each other. The total thickness of the obtained adhesive film was approximately 1 mm. Circles of 8 mm diameter were cut with a die and these samples were mounted on an 8 mm diameter stainless steel parallel plate fixture of an Ares 2000EX rheometer (TA Instruments, New Castle, Del.).

The test procedure for evaluation of storage moduli was a set of temperature sweeps in torque mode at an angular frequency of 1 rad/sec. The first temperature range was from −50° C. to 25° C. using 3° C. steps at 1% strain and stress of 10,000 Pa. The second temperature range was from 25° C. to 185° C. and covered in 3° C. increments using a strain of 5% and stress of 10,000 Pa. A shear modulus of 2 MPa or less is desired over the use temperature range of the device, which is typically from about −30° C. to about 90° C.

### Creep Test

Percent strain at 90 kPa and percent recovery of adhesives at RT were evaluated using a Discovery HR-3 Hybrid rheometer (TA instruments, New Castle, Del.) according to the following two-stage procedure: in the first stage, to determine percent strain, adhesive samples (circles of 8 mm diameter and approximately 1 mm thick) were subjected to constant shear stress of 90 kPa at room temperature for 5 seconds. In the second stage, the constant shear stress of 90 kPa was removed and relaxation of the samples was measured during 60 seconds at room temperature. The shear creep compliance, J, at any time following the application of the stress is defined as the ratio of the shear strain at that time divided by the applied stress. To ensure sufficient compliance within the assembly layer, it is preferred that the peak shear strain after applying the load in the test described above is greater than about 200%. Note that at higher stresses, which can be 100, 200, or even 500 kPa that the peak strain will increase. Furthermore, to minimize material creep within the flexible assembly, it is preferred that the material recover greater that about 50% strain 60 seconds after the applied stress is removed. The percent recoverable strain is defined as ((S₁-S₂)/S₁)*100 where S₁ is the shear strain recorded at the peak at 5 seconds after applying the stress and S₂ is the shear strain measured at 60 seconds after the applied stress is removed.

### T-Peel Adhesion Test

PET/OCA/PET 1″ wide constructions were used for measurements in this test. In order to obtain cohesive split under T-peel test, OCA films (4 mil and 2 mil in the case of Example 7) and PET (3 mil) film backing were corona treated prior to lamination using the Model BD-20 Laboratory Corona Treater. T-peel adhesion was measured by Instron at room temperature as an average force per unit test sample width along the bond line of OCA between two flexible PET backings. T-peel adhesion values were reported as an arithmetic average of measurements for two samples. If the test results in the desired cohesive failure, a higher number is indicative of higher cohesive strength.

### Recovery Angle Test

In order to imitate some conditions of OCA mechanical exploitation as a layer in a flexible display (for example, a flexible display device can be closed, left closed for some time, and then re-opened again) and to understand which OCA rheological profile will deliver the best performance, a recovery angle test was performed.

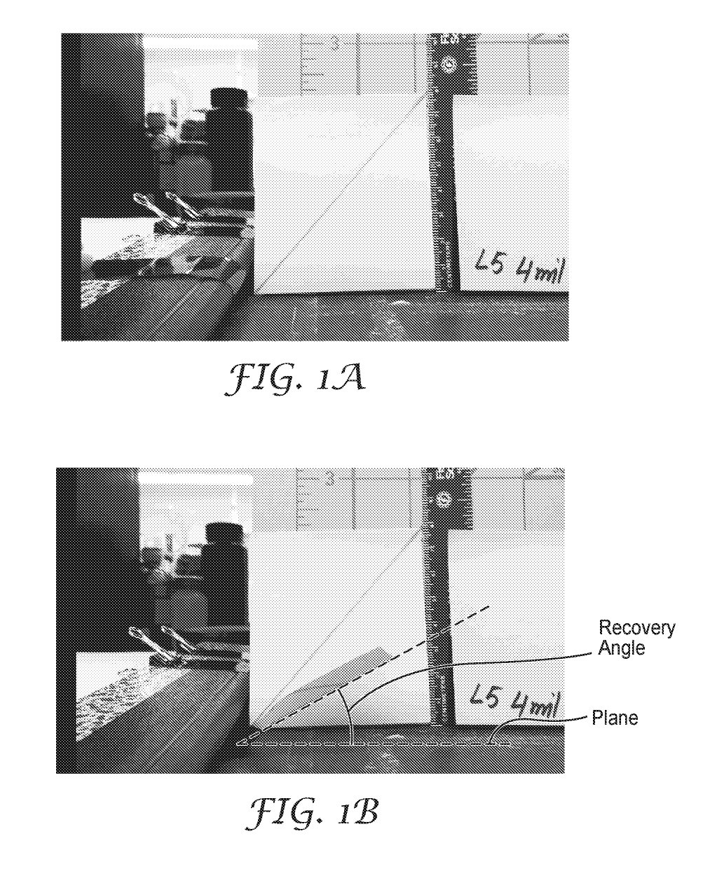

Test specimens were prepared by laminating OCA between 1.7 mil thick polyimide strips approximately 1″ wide by 5″ long. The thickness of the OCA samples was 2 or 4 mil. The test specimens were bent around a mandrel having a radius of curvature of approximately 5 mm and fastened securely. After 24 hours at room temperature, one end of each sample was unfastened and allowed to recover for 90 second before their recovery angle (relative to the plane, as it is indicated in FIG. 1B) was recorded. FIG. 1 shows images of (A) a test specimen bent around the mandrel, (B) a test specimen that has been unfastened and allowed to recover for 90 seconds.

### Static Folding Test

A 2 mil thick OCA was laminated between either 1.7 mil or 1 mil thick sheets of polyimide. These laminates were then cut to a 1″ wide and 5″ length. The laminate was then bent around a 5 or 3 mm radius (R) of curvature and held in that position for 24 hours at room temperature or at −20° C. After 24 hours at room temperature, the laminate was released and allowed to recover. The recovery angles (relative to the initial plane) were recorded at 90 and 180 seconds after release. After 24 hours at −20° C., the samples were held at room temperature for one hour before data collection. A smaller recovery angle is generally preferred.

### Dynamic Folding Test

A 2 mil thick OCA was laminated between 1 mil sheets of polyimide and then cut to a 5″ length×1″ width. The sample was mounted in a dynamic folding device with two folding tables that rotate from 180 degrees (i.e. sample is not bent) to 0 degrees (i.e. sample is now folded) for 100,000 cycles. The test rate is about 20 cycles/minute. The bend radius of 3 mm is determined by the gap between the two rigid plates in the closed state (0 degrees). Folding was done at room temperature. Failure (such as delamination, buckling,etc.) in this test was observed and recorded but the test also depends strongly on the type and thickness of the adherends.

### Optical Properties Test

Two sets of samples were prepared for the evaluation of durability of optical performance: the first one is OCA laminated between two SH81 PET film backings, and the second one is OCA laminated onto an Eagle XC LCD glass followed by lamination of T10 release liner onto the OCA to form a final laminate having T10/OCA/LCD glass construction. Adhesives were 2 mil thick in Examples 2 and 6, and 4 mil thick in Comparative Example 1. The initial optical performance of these samples was measured. In case of T10/OCA/LCD glass construction, T10 release liner was removed each time when optical properties were measured. Samples were put into three different environmental conditions: 85° C. without controlled humidification, 85° C. and 85% relative humidity (RH), and 65° C. and 90% relative humidity. Their optical performance was evaluated at 240, 500, and 1000 hours of environmental aging.

Measurements of transmittance, haze and b*coordinate were performed using an ULTRAScanPro instrument (Hunter Associates Laboratory, Inc., Reston, Va.). Program EasyMatchQC Manager, version 4.7, was used as a master of experiment (Hunter Associates Laboratory, Inc., Reston, Va.). Air was used as a standard. The optical test is only required if the material is to be used as an OCA. In such case it will have to meet the specifications of an OCA, i.e. a luminous transmission of greater than about 90 percent, a haze of less than about 5%, particularly less than 2%, and opacity of less than about 1 percent in the 400 to 700 nm wavelength range.

### Adhesive Films Preparation Procedure

Three grades of acrylic block copolymers having an A-B-A structure and one grade having A-B structure with poly(methyl methacrylate) hard block polymeric units (the A blocks) and poly(n-butyl acrylate) soft block polymeric units (the B blocks) were used for formulation of acrylic block copolymer-based optically clear adhesives. These block copolymers are available as “LA2330”, “LA2140e”, “LA2250” and “LA1114” from Kuraray America, Inc. Their descriptions are provided in Table 1. Examples C1, C2, and C3 are comparative examples.

Solutions of Kurarity™ polymers in ethyl acetate (40% solids) were added to glass vessels in the proportions required to formulate the compositions listed in Table 2. The combined polymer solutions were mixed by shaker for 24 hours prior to coating. Adhesive films were formed by knife-coating the polymer solutions onto T10 release liner. Wet gaps of 7.5 mil, 15 mil, and 50 mil were used to obtain, respectively, adhesive films with thicknesses of approximately 2 mil, 4 mil, and 13 mil. The coatings with wet gaps of 7.5 and 15 mil were placed in an oven at 40° C. for 20 minutes and the coatings with wet gap of 50 mil were placed in an oven at 40° C. for 60 min to remove the ethyl acetate solvent.

TABLE 1
Kurarity ™ acrylic block copolymers.

| Kurarity ™ | | | |
|---|---|---|---|
| acrylic block | | | Total polymer |
| copolymers | Structure | % PMMA | M_{w}, g/mol |
| LA1114 | A-B | 7 | 60,000 |
| LA2140e | A-B-A | 24 | 70,000 |
| LA2330 | A-B-A | 24 | 120,000 |
| LA2250 | A-B-A | 33 | 60,000 |

TABLE 2
Acrylic block copolymer-based OCAs: Composition.

| | Composition Triblock/Diblock |
|---|---|
| Example | (weight ratio) |
| 1 | LA2330/LA1114 (100/0) |
| 2 | LA2330/LA1114 (75/25) |
| 3 | LA2330/LA1114 (70/30) |
| 4 | LA2330/LA1114 (65/35) |
| 5 | LA2330/LA1114 (50/50) |
| 6 | LA2330/LA1114 (45/55) |
| 7 | LA2330/LA1114 (35/65) |
| 8 | LA2140e/LA1114 (75/25) |
| 9 | LA2140e/LA1114 (45/55) |
| 10 | LA2250/LA1114 (45/55) |
| 11 | LA2330/LA1114 (25/75) |
| 12 | LA2140e/LA1114 (25/75) |
| 13 | LA2250/LA1114 (25/75) |

Rheological properties, percent strain, T-peel adhesion, recovery, static, dynamic folding test results and optical performance before and after environmental aging of acrylic block copolymer-based OCAs are given in Tables 3-10.

TABLE 3
Storage moduli at three different temperatures
of acrylic block copolymer-based OCAs.

| | Composition | | | |
|---|---|---|---|---|
| | Triblock/Diblock | G′, MPa | | |
| Example | (weight ratio) | at −20° C. | RT | 60° C. |
| 1 | LA2330/LA1114 (100/0) | 0.44 | 0.19 | 0.15 |
| 2 | LA2330/LA1114 (75/25) | 0.22 | 0.07 | 0.05 |
| 3 | LA2330/LA1114 (70/30) | 0.30 | 0.09 | 0.06 |
| 4 | LA2330/LA1114 (65/35) | 0.29 | 0.08 | 0.05 |
| 5 | LA2330/LA1114 (50/50) | 0.24 | 0.04 | 0.02 |
| 6 | LA2330/LA1114 (45/55) | 0.24 | 0.03 | 0.02 |
| 7 | LA2330/LA1114 (35/65) | 0.19 | 0.02 | 0.01 |
| 8 | LA2140e/LA1114 (75/25) | 0.48 | 0.11 | 0.07 |
| 9 | LA2140e/LA1114 (45/55) | 0.26 | 0.04 | 0.02 |
| 10 | LA2250/LA1114 (45/55) | 0.4 | 0.07 | 0.04 |
| 11 | LA2330/LA1114 (25/75) | 0.22 | 0.01 | 0.004 |
| 12 | LA2140e/LA1114 (25/75) | 0.26 | 0.02 | 0.005 |
| 13 | LA2250/LA1114 (25/75) | 0.24 | 0.02 | 0.01 |

TABLE 4
% Strain measured by the creep test at 90 kPa and %
Recovery at RT of acrylic block copolymer-based OCAs.

| | Composition | | |
|---|---|---|---|
| | Triblock/Diblock | Strain at | Recovery, |
| Example | (weight ratio) | 90 kPa, % | % |
| 1 | LA2330/LA1114 (100/0) | 60 | 98 |
| 2 | LA2330/LA1114 (75/25) | 130 | 95 |
| 3 | LA2330/LA1114 (70/30) | 190 | 96 |
| 4 | LA2330/LA1114 (65/35) | 220 | 97 |
| 5 | LA2330/LA1114 (50/50) | 370 | 96 |
| 6 | LA2330/LA1114 (45/55) | 610 | 89 |
| 7 | LA2330/LA1114 (35/65) | 600 | 89 |
| 8 | LA2140e/LA1114 (75/25) | 130 | 98 |
| 9 | LA2140e/LA1114 (45/55) | 370 | 95 |
| 10 | LA2250/LA1114 (45/55) | 190 | 97 |
| 11 | LA2330/LA1114 (25/75) | 880 | 82 |
| 12 | LA2140e/LA1114 (25/75) | 750 | 83 |
| 13 | LA2250/LA1114 (25/75) | 470 | 94 |

TABLE 5
T-peel adhesion of acrylic block copolymer-based OCAs.

| | Composition | | |
|---|---|---|---|
| | Triblock/Diblock | T-peel adhesion, | Mode of |
| Example | (weight ratio) | g-force/in | Failure |
| 1 | LA2330/LA1114 (100/0) | 5000 | Cohesive |
| 2 | LA2330/LA1114 (75/25) | 3800 | Cohesive |
| 3 | LA2330/LA1114 (70/30) | 3500 | Cohesive |
| 4 | LA2330/LA1114 (65/35) | 3300 | Cohesive |
| 5 | LA2330/LA1114 (50/50) | 2400 | Cohesive |
| 6 | LA2330/LA1114 (45/55) | 1900 | Cohesive |
| 7 | LA2330/LA1114 (35/65) | 900 | Cohesive |
| 8 | LA2140e/LA1114 (75/25) | 4100 | Cohesive |
| 9 | LA2140e/LA1114 (45/55) | 1300 | Cohesive |
| 10 | LA2250/LA1114 (45/55) | 1300 | Cohesive |
| 11 | LA2330/LA1114 (25/75) | 500 | Cohesive |
| 12 | LA2140e/LA1114 (25/75) | 400 | Cohesive |
| 13 | LA2250/LA1114 (25/75) | 400 | Cohesive |

TABLE 6
Recovery Angle test results at 90 seconds after release
of acrylic block copolymer-based OCAs after 24 hours
folding (R = 5 mm) at room temperature for 24 h
(2 mil OCA between two 1.7 mil thick polyimide films
and 4 mil OCA between two 1.7 mil thick polyimide films).

| | | Recovery Angle at 90 sec | |
|---|---|---|---|
| | Composition | after release, degrees | |
| | Triblock/Diblock | 2 mil | 4 mil |
| Example | (weight ratio) | thick OCA | thick OCA |
| 1 | LA2330/LA1114 (100/0) | 18 | 22 |
| 2 | LA2330/LA1114 (75/25) | 19 | 20 |
| 4 | LA2330/LA1114 (65/35) | 20 | 32 |
| 6 | LA2330/LA1114 (45/55) | 34 | 41 |
| 8 | LA2140e/LA1114 (75/25) | 28 | 34 |
| 9 | LA2140e/LA1114 (45/55) | 45 | 45 |
| 10 | LA2250/LA1114 (45/55) | 32 | 45 |
| 11 | LA2330/LA1114 (25/75) | No data | 58 |
| 12 | LA2140e/LA1114 (25/75) | No data | 75 |
| 13 | LA2250/LA1114 (25/75) | No data | 69 |

TABLE 7A
Static Folding (R = 5 mm) test results of acrylic block
copolymer-based OCAs after room temperature for 24 hours exposure
(4 mil OCA between two 1.7 mil thick polyimide films).

| | Composition | |
|---|---|---|
| | Triblock/Diblock | Static Folding |
| Example | (weight ratio) | Angle at 90 sec, ° |
| 1 | LA2330/LA1114 (100/0) | 26 |
| 2 | LA2330/LA1114 (75/25) | 17 |
| 4 | LA2330/LA1114 (65/35) | 35 |
| 6 | LA2330/LA1114 (45/55) | 45 |
| 8 | LA2140e/LA1114 (75/25) | 27 |
| 9 | LA2140e/LA1114 (45/55) | 50 |
| 10 | LA2250/LA1114 (45/55) | 61 |
| 11 | LA2330/LA1114 (25/75) | 58 |
| 12 | LA2140e/LA1114 (25/75) | 80 |
| 13 | LA2250/LA1114 (25/75) | 71 |

TABLE 7B
Static Folding (R = 3 mm) test results of acrylic
block copolymer-based OCAs after a 24 hour exposure
to −20° C. followed by one hour at room temperature
(2 mil OCA between two 1 mil thick polyimide films).

| | Composition | Static Folding | | |
|---|---|---|---|---|
| | Triblock/Diblock | Angle | Angle | |
| Example | (weight ratio) | at 90 s | at 180 s | Notes |
| 1 | LA2330/LA1114 (100/0) | 19 | 12 | no defects |
| 3 | LA2330/LA1114 (70/30) | 20 | 13 | no defects |
| 4 | LA2330/LA1114 (65/35) | 30 | 22 | no defects |
| 5 | LA2330/LA1114 (50/50) | 49 | 41 | no defects |
| 6 | LA2330/LA1114 (45/55) | 50 | 43 | no defects |
| 7 | LA2330/LA1114 (35/65) | 44 | 28 | no defects |
| 11 | LA2330/LA1114 (25/75) | 41 | 28 | buckling |

TABLE 7C
Static Folding (R = 3 mm) test results of acrylic block
copolymer-based OCAs after room temperature for 24 hours exposure
(2 mil OCA between two 1 mil thick polyimide films).

| | Composition | Static Folding | | |
|---|---|---|---|---|
| | Triblock/Diblock | Angle | Angle | |
| Example | (weight ratio) | at 90 s | at 180 s | Notes |
| 1 | LA2330/LA1114 (100/0) | 49 | 45 | no defects |
| 4 | LA2330/LA1114 (65/35) | 23 | 7 | no defects |
| 7 | LA2330/LA1114 (35/65) | 25 | 21 | no defects |
| 11 | LA2330/LA1114 (25/75) | 57 | 50 | buckling |

TABLE 8
Dynamic Folding (R = 3 mm) test results
of acrylic block copolymer-based OCAs (2 mil
OCA between two 1 mil thick polyimide films).

| | Composition | Dynamic Folding |
|---|---|---|
| | Triblock/Diblock | 100 K cycles at RT |
| Example | (weight ratio) | Notes |
| 1 | LA2330/LA1114 (100/0) | no defects |
| 7 | LA2330/LA1114 (35/65) | no defects |
| 11 | LA2330/LA1114 (25/75) | buckling |

TABLE 9
Optical properties of acrylic block copolymer-based OCAs.

| | | | | SH81/OCA/SH81 | | | LCD/OCA | | |
|---|---|---|---|---|---|---|---|---|---|
| | | | | Example | Example | Example | Example | Example | Example |
| Optical Performance/Sample | | | | 2 | 6 | 11 | 2 | 6 | 11 |
| Optical | 0 | h | b* | 0.51 | 0.56 | 0.6 | 0.22 | 0.13 | 0.18 |
| at 85° | | | Haze | 1.4 | 1.3 | 1.5 | 2.2* | 0.9 | 0.7 |
| C./Dry | | | % T (350-1050 nm) | 88 | 87.9 | 88 | 92.2 | 92.3 | 92.3 |
| | 240 | h | b* | 0.77 | 0.79 | 0.76 | 0.22 | 0.18 | 0.21 |
| | | | Haze | 1.3 | 1.2 | 1.4 | 2.2* | 1.2 | 0.7 |
| | | | % T (350-1050 nm) | 87.5 | 87.5 | 87.5 | 92.2 | 92.2 | 92.2 |
| | 500 | h | b* | 0.94 | 0.93 | 0.9 | 0.22 | 0.22 | 0.22 |
| | | | Haze | 1.6 | 1.7 | 1.6 | 1.8 | 1.5 | 0.6 |
| | | | % T (350-1050 nm) | 87.7 | 87.4 | 87.4 | 92.1 | 92 | 92.2 |
| | 1000 | h | b* | 0.83 | 0.82 | 0.86 | 0.23 | 0.21 | 0.28 |
| | | | Haze | 1.4 | 1.3 | 1.2 | 1.8 | 0.8 | 0.6 |
| | | | % T (350-1050 nm) | 87.4 | 87.6 | 87.4 | 92 | 92.2 | 92 |
| Optical | 0 | h | b* | 0.51 | 0.56 | 0.6 | 0.22 | 0.13 | 0.18 |
| at 85° | | | Haze | 1.4 | 1.3 | 1.5 | 2.2* | 0.9 | 0.7 |
| C./85% | | | % T (350-1050 nm) | 88 | 87.9 | 88 | 92.2 | 92.3 | 92.3 |
| RH | 240 | h | b* | 0.71 | 0.74 | 0.83 | 0.22 | 0.18 | 0.2 |
| | | | Haze | 2.2 | 1.9 | 2.4 | 2.2* | 1.2 | 0.7 |
| | | | % T (350-1050 nm) | 87.7 | 87.4 | 87.3 | 92.2 | 92.2 | 92.1 |
| | 500 | h | b* | 0.77 | 0.83 | 0.9 | 0.23 | 0.22 | 0.23 |
| | | | Haze | 1.3 | 1.4 | 1.3 | 2.2* | 1.3 | 0.9 |
| | | | % T (350-1050 nm) | 87.5 | 87.3 | 87.4 | 91.9 | 92.4 | 92.4 |
| | 1000 | h | b* | 0.92 | 0.86 | 0.82 | 0.24 | 0.23 | 0.23 |
| | | | Haze | 1.4 | 1.4 | 1.4 | 1.8 | 1 | 0.5 |
| | | | % T (350-1050 nm) | 86.9 | 87.2 | 87.2 | 91.8 | 92.8 | 92.3 |
| Optical | 0 | h | b* | 0.51 | 0.56 | 0.6 | 0.22 | 0.13 | 0.18 |
| at 65° | | | Haze | 1.4 | 1.3 | 1.5 | 2.2* | 0.9 | 0.7 |
| C./90% | | | % T (350-1050 nm) | 88 | 87.9 | 88 | 92.2 | 92.3 | 92.3 |
| RH | 240 | h | b* | 0.59 | 0.62 | 0.76 | 0.2 | 0.17 | 0.19 |
| | | | Haze | 1.7 | 1.8 | 1.4 | 1.7 | 1 | 1 |
| | | | % T (350-1050 nm) | 88 | 87.8 | 87.5 | 92.2 | 92.3 | 92.2 |
| | 500 | h | b* | 0.61 | 0.68 | 0.88 | 0.26 | 0.2 | 0.19 |
| | | | Haze | 1.7 | 1.4 | 1.5 | 1.5 | 1 | 0.7 |
| | | | % T (350-800 nm) | 86.9 | 88 | 87.5 | 92.2 | 92.1 | 92.1 |
| | 1000 | h | b* | 0.71 | 0.77 | 0.82 | 0.18 | 0.19 | 0.21 |
| | | | Haze | 1.6 | 1.6 | 1.8 | 1.3 | 0.7 | 0.5 |
| | | | % T (350-800 nm) | 87.5 | 87.6 | 87.3 | 92 | 92.2 | 92.1 |

*this % haze value is due to imprint from T10 release liner.

Although the present invention has been described with reference to preferred embodiments, workers skilled in the art will recognize that changes may be made in form and detail without departing from the spirit and scope of the invention.

1. An assembly layer for a flexible device, wherein the assembly layer is derived from precursors comprising:
an acrylic block copolymer comprising:
at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block; and
at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10° C., and wherein the acrylic block copolymer comprises about 50 to about 95 weight percent B block;
wherein within a temperature range of between about −30° C. to about 90° C., the assembly layer has a shear storage modulus at a frequency of 1 rad/sec that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

2. The assembly layer of claim 1, wherein the assembly layer is optically clear.

3. The assembly layer of claim 1, wherein the flexible device is an electronic display device.

4. The assembly layer of claim 1, wherein the B block of the acrylic block copolymer comprises a low glass transition temperature acrylate containing at least 4 carbons in the alkyl group.

5. The assembly layer of claim 1, wherein the acrylic block copolymer is based on at least two A blocks of a polymethylmethacrylate, and at least on B block selected from a poly-n-butyl acrylate, a polyisooctyl acrylate, and a poly-2-ethyl hexyl acrylate.

6. The assembly layer of claim 1, further comprising at least one of a tackifier, a plasticizer, a UV stabilizer, a UV absorber, nanoparticles, a cross-linker, and a coupling agent.

7. A flexible laminate comprising:
a first flexible substrate;
a second flexible substrate; and
an acrylic block copolymer-based assembly layer positioned between and in contact with the first flexible substrate and the second flexible substrate, the acrylic block copolymer-based assembly layer comprising:
at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block; and
at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10 ° C., and wherein the acrylic block copolymer comprises about 50 to about 95 weight percent B block;
wherein within a temperature range of between about −30° C. to about 90° C., the assembly layer has a shear storage modulus at a frequency of 1 rad/sec that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress.

8. The flexible laminate of claim 7, wherein the assembly layer is optically clear.

9. The flexible laminate of claim 7, wherein at least one of the first and second substrates is optically clear.

10. The flexible laminate of claim 7, wherein the acrylic block copolymer is based on at least two A blocks of a polymethylmethacrylate, and at least one B block of a poly-n-butyl acrylate, a polyisooctyl acrylate, and a poly-2-ethyl hexyl acrylate.

11. (canceled)

12. The flexible laminate of claim 7, wherein the laminate does not exhibit failure when placed within a channel forcing a radius of curvature of less than about 15 mm over a period of 24 hours at room temperature.

13. The flexible laminate of claim 12, wherein the laminate returns to an included angle of at least about 130 degrees after removal from the channel after the 24 hour period at room temperature.

14. The flexible laminate of claim 7, wherein the laminate does not exhibit failure when subjected to a dynamic folding test at room temperature of about 10,000 cycles of folding with a radius of curvature of less than about 15 mm.

15. A method of adhering a first substrate and a second substrate, wherein both of the first and the second substrates are flexible, the method comprising:
positioning an assembly layer between the first substrate and the second substrate to form a flexible laminate, wherein the assembly layer is derived from components that comprise:
an acrylic block copolymer comprising:
at least two A block polymeric units that are the reaction product of a first monomer composition comprising an alkyl methacrylate, an aralkyl methacrylate, an aryl methacrylate, or a combination thereof, wherein each A block has a Tg of at least about 50° C., and wherein the acrylic block copolymer comprises about 5 to about 50 weight percent A block; and
at least one B block polymeric unit that is the reaction product of a second monomer composition comprising an alkyl (meth)acrylate, a heteroalkyl (meth)acrylate, a vinyl ester, or a combination thereof, wherein the B block has a Tg no greater than about 10° C., and wherein the acrylic block copolymer comprises about 50 to about 95 weight percent B block;
wherein within a temperature range of between about −30° C. to about 90° C., the assembly layer has a shear storage modulus at a frequency of 1 rad/sec that does not exceed about 2 MPa, a shear creep compliance (J) of at least about 6×10⁻⁶ 1/Pa measured at 5 seconds with an applied shear stress between about 50 kPa and about 500 kPa, and a strain recovery of at least about 50% at at least one point of applied shear stress within the range of about 5 kPa to about 500 kPa within about 1 minute after removing the applied shear stress; and
applying at least one of pressure and heat to form a laminate.

16. The method of claim 15, wherein the assembly layer is optically clear.

17. The method of claim 15, wherein the laminate does not exhibit failure when placed within a channel forcing a radius of curvature of less than about 15 mm over a period of 24 hours at room temperature.

18. The method of claim 17, wherein the laminate returns to an included angle of at least about 130 degrees after removal from the channel after the 24 hour period at room temperature.

19. The method of claim 15, wherein the laminate does not exhibit failure when subjected to a dynamic folding test at room temperature of greater than about 10,000 cycles of folding with a radius of curvature of less than about 15 mm.

20. The method of claim 15, wherein the B block of the acrylic block copolymer comprises a low glass transition temperature acrylate containing at least 4 carbons in the alkyl group.

21. The method of claim 15, wherein the acrylic block copolymer is based on at least two A blocks of a polymethylmethacrylate, and at least one B block of a poly-n-butyl acrylate, a polyisooctyl acrylate, and a poly-2-ethyl hexyl acrylate.
